(19) United States
(12) Patent Application Publication
(10) Pub. No.: US 2026/0204662 A1
(43) Pub. Date: Jul. 16, 2026

(54) ELECTROCHEMICAL APPARATUS AND ELECTRONIC DEVICE

(71) Applicant: Ningde Amperex Technology Limited, Ningde (CN)

(72) Inventors: Xinlai ZHENG, Ningde (CN); Yajie LI, Ningde (CN); Minjing CHEN, Ningde (CN)

(73) Assignee: Ningde Amperex Technology Limited, Ningde (CN)

(21) Appl. No.: 19/566,001

(22) Filed: Mar. 13, 2026

Related U.S. Application Data
(63) Continuation of application No. PCT/CN2023/119046, filed on Sep. 15, 2023.

(51) Int. Cl. H01M 10/42; H01M 4/02; H01M 4/133; H01M 4/134; H01M 4/36; H01M 4/38; H01M 4/587; H01M 4/62; H01M 10/0525; H01M 10/0567; H01M 10/0568; H01M 10/0569

(52) U.S. Cl. CPC H01M 10/4235; H01M 4/133; H01M 4/134; H01M 4/364; H01M 4/386; H01M 4/587; H01M 4/62; H01M 10/0567; H01M 10/0568; H01M 10/0569; H01M 2004/021; H01M 2004/027; H01M 10/0525; H01M 2300/004

(57) ABSTRACT

An electrochemical apparatus includes a negative electrode plate. The negative electrode plate includes a negative electrode active material, and the negative electrode active material includes a silicon-based material. The silicon-based material is obtained by providing a surface coating layer on a surface of a silicon particle. The surface coating layer includes a soluble polymer, and the soluble polymer is soluble in an electrolyte. After the electrolyte is injected into the electrochemical apparatus, a mass concentration of the soluble polymer in the electrolyte is 0.2 wt % to 6 wt %.

### CROSS-REFERENCE TO RELATED APPLICATIONS

This application is a continuation application of International Application No. PCT/CN2023/119046, filed on Sep. 15, 2023, the content of which is incorporated herein by reference in its entirety.

### TECHNICAL FIELD

This application relates to the field of battery technology, in particular to an electrochemical apparatus and an electronic device.

### BACKGROUND

Lithium-ion batteries have the advantages such as high energy density, high operating voltage, and low environmental pollution, and have been widely used in various small portable apparatuses such as mobile phones, digital cameras, laptops, and drones. In non-carbon negative electrode active materials, the theoretical gram capacity of silicon materials is up to 4200 mAh/g, which is 10 times higher than that of the current commercialized graphite negative electrodes. The use of silicon negative electrodes can significantly increase the energy density of lithium-ion batteries. However, the relatively low compacted density of silicon materials results in significant thickness rebound of silicon electrode plates during processing, leading to unsatisfactory cycling performance and rate performance of lithium-ion batteries including silicon negative electrodes.

### SUMMARY

In view of this, this application provides an electrochemical apparatus and an electronic device. In the electrochemical apparatus in this application, a surface coating layer is provided on a surface of a silicon particle. After the silicon particle with the surface coating layer comes into contact with an electrolyte, the surface coating layer is dissolved, allowing the silicon particle to have larger expansion space, thereby suppressing the thickness rebound issue of silicon-based electrode plates during processing.

According to a first aspect, this application provides a negative electrode plate. The negative electrode plate includes a negative electrode active material. The negative electrode active material includes a silicon-based material. The negative electrode active material is obtained by providing a surface coating layer on a surface of a silicon particle. The surface coating layer includes a soluble polymer, and the soluble polymer is configured to be soluble in an electrolyte. After the surface coating layer is dissolved, the silicon particle forms large gaps with surrounding particles. During charging and discharging, the expansion of the silicon particle exerts small pressure on the surrounding particles, significantly suppressing the expansion of the entire electrode plate, thereby suppressing the expansion issues during cycling and improving the rate performance of a battery.

In some embodiments, after the electrolyte is injected into the electrochemical apparatus, the soluble polymer is dissolved in the electrolyte. A mass ratio of the soluble polymer to the silicon particle is within a range of (0.05-1.2):1. Making the mass ratio of the soluble polymer to the silicon particle fall within the above range is conducive to reducing the thickness expansion rate of the electrode plate and improving the cycling performance of a lithium-ion battery.

In some embodiments, further, the mass ratio of the soluble polymer to the silicon particle is within a range of (0.3-0.5):1. Making the mass ratio of the soluble polymer to the silicon particle fall within the above range is conducive to further reducing the thickness expansion rate of the electrode plate and improving the cycling performance of the lithium-ion battery.

In some embodiments, the surface coating layer further includes carbon nanotubes. A mass ratio of the carbon nanotube to the silicon particle is within a range of (0.005-0.1):1. Making the mass ratio of the carbon nanotube to the silicon particle fall within the above range is conducive to further reducing the thickness expansion rate of the electrode plate and improving the cycling performance of the lithium-ion battery.

According to a second aspect, this application provides an electrochemical apparatus. The electrochemical apparatus includes a negative electrode plate, and the negative electrode plate includes a negative electrode active material. The negative electrode active material includes a silicon-based material, and the silicon-based material is obtained by providing a surface coating layer on a surface of a silicon particle. The surface coating layer includes a soluble polymer, and the soluble polymer is soluble in an electrolyte. After the surface coating layer is dissolved, the silicon particle forms large gaps with surrounding particles. During charging and discharging, the expansion of the silicon particle exerts small pressure on the surrounding particles, significantly suppressing the expansion of the entire electrode plate, thereby suppressing the expansion issues during cycling and improving the rate performance of the battery.

In some embodiments, after the electrolyte is injected into the electrochemical apparatus, the soluble polymer is dissolved in the electrolyte. Further, a mass concentration of the soluble polymer in the electrolyte is within a range of 0.2 wt % to 6 wt %. Making the mass concentration of the soluble polymer in the electrolyte fall within the above range is conducive to reducing the thickness expansion rate of the electrode plate and improving the high-temperature cycling performance of the lithium-ion battery. Preferably, the mass concentration of the soluble polymer in the electrolyte is within a range of 1.3 wt % to 1.5 wt %.

In some embodiments, the electrolyte includes linear ester and cyclic ester, and a mass ratio of the linear ester to the cyclic ester is within a range of (1-4):(4-1). In this case, an appropriate ionic conductivity of the electrolyte facilitates the dissolution of the soluble polymer in the surface coating layer, and also allows for better permeation into pores of the negative electrode plate, thereby improving the rate performance of the lithium-ion battery. Preferably, the mass ratio of the linear ester to the cyclic ester is within a range of (1-3):1.

In some embodiments, the soluble polymer includes an alcohol-soluble resin, and the alcohol-soluble resin is selected from at least one of alcohol-soluble polyamide resin, alcohol-soluble acrylic resin, or alcohol-soluble polyurethane resin. Preferably, the alcohol-soluble resin includes alcohol-soluble polyurethane resin.

In some embodiments, a molecular weight of the alcohol-soluble resin is within a range of 8×10³ to 1.5×10⁵. Making the molecular weight of the alcohol-soluble resin fall within the above range is more conducive to achieving an appropriate mass concentration of the alcohol-soluble resin in the electrolyte, providing the silicon particles with larger free expansion space on the surfaces of the silicon particles, thereby further helping to reduce the thickness expansion rate of the electrode plate.

In some embodiments, a mass ratio of the soluble polymer to the silicon particle is within a range of (0.05-1.2):1. Preferably, the mass ratio of the soluble polymer to the silicon particle is within a range of (0.3-0.5):1. This is more conducive to reducing the thickness expansion rate of the negative electrode plate.

In some embodiments, a mass ratio of the carbon nanotube to the silicon particle is within a range of 0.005:1 to 0.1:1. Preferably, the mass ratio of the carbon nanotube to the silicon particle is within a range of (0.01-0.05):1.

In some embodiments, the carbon nanotubes include single-walled carbon nanotubes, and an aspect ratio of the single-walled carbon nanotubes is within a range of 1×10⁴ to 4×10⁴. Preferably, the aspect ratio of the single-walled carbon nanotubes is within a range of 2.5×10⁴ to 3×10⁴.

In some embodiments, a dissolution amount of the soluble polymer in a specific solution is greater than 80%. The specific solution includes linear ester and cyclic ester, and a mass ratio of the linear ester to the cyclic ester is 3:1. The dissolution amount refers to a mass of the soluble polymer dissolved in the solution after being soaked at 60° C. in the specific solution.

A testing method for the dissolution amount includes: preparing an adhesive film from the soluble polymer; weighing the adhesive film to obtain m0; soaking the adhesive film prepared from the polymer in the specific electrolyte at 60° C. until the weight of the adhesive film no longer changes; removing the soaked adhesive film; drying the adhesive film; and weighing the adhesive film to obtain a mass m1, where dissolution amount C0=(m0−m1)/m0.

In some embodiments, a porosity of the negative electrode plate is within a range of 25% to 48%. Preferably, the porosity of the negative electrode plate is within a range of 25% to 33%.

In some embodiments, a contact angle of the negative electrode plate with the electrolyte is within a range of 0° to 45°.

In some embodiments, the negative electrode active material further includes graphite, and a mass ratio of the silicon particle to the graphite is within a range of 1:23 to 29:1.

In some embodiments, a thickness of the surface coating layer is within a range of 0.5 μm to 10 μm. Preferably, the thickness of the surface coating layer is within a range of 2 μm to 3 μm.

It should be noted that the thickness of the surface coating layer varies correspondingly with a change in a mass ratio m1/m2 of the soluble polymer to the silicon particle. Specifically, m1 represents a mass fraction of the soluble polymer, and m2 represents a mass fraction of the silicon particle. When the mass fraction m1 of the soluble polymer is reduced (that is, the mass ratio is reduced), the thickness of the surface coating layer is also reduced correspondingly. When the mass fraction m1 of the soluble polymer is increased (that is, the mass ratio is increased), the thickness of the surface coating layer is also increased correspondingly.

According to a third aspect, this application provides electronic device, and the electronic device includes the foregoing electrochemical apparatus.

Beneficial effects brought by the technical solutions provided by some embodiments of this application include at least the following: this application provides an electrochemical apparatus. In the electrochemical apparatus, a surface coating layer is provided on a surface of a silicon particle of the negative electrode active material. The surface coating layer includes a soluble polymer, and the soluble polymer is soluble in an electrolyte. After dissolution, gaps are reserved between the silicon particle and surrounding particles. On one hand, during charging and discharging, the expansion of the silicon particle exerts small pressure on the surrounding particles, which is conducive to reducing the thickness expansion rate of the electrode plate, thereby improving the cycling performance of the lithium-ion battery, especially the high-temperature cycling performance. On the other hand, it facilitates better permeation of the electrolyte into pores of the negative electrode plate, thereby improving the rate performance of the lithium-ion battery.

### DETAILED DESCRIPTION

To make the objectives, technical solutions, and advantages of this application clearer, this application is further described in detail below with reference to some embodiments. It should be understood that the specific embodiments described herein are merely used to explain this application and are not intended to limit this application.

Currently, improvements in the low compacted density of high-capacity silicon-based materials mainly focus on the following aspects: (1) improvement in particle size or morphology, such as nanosizing of SiO, SiC, or the like, where nanomaterials can, to some extent, mitigate volume effects, offering better stacking effects and higher compacted density; and (2) use of new high-adhesivity binders. However, the use of a composite nanomaterial such as SiO or SiC poses two common issues. A gram capacity of an Si composite material is lower than that of pure Si, and an actual reversible gram capacity is even lower. For example, a gram capacity of an SiO negative electrode material is 2400 mAh/g, with an actual reversible gram capacity of about 1500 mAh/g. Another common issue of a silicon composite material is electrode pulverization during cycling, which leads to failure of electronic and ionic conductive pathways and poor cycling performance. Moreover, due to complex processes of composite materials, the preparation cost of nanostructured Si materials remains high, and reducing a size of Si from bulk to nanoscale at least doubles the processing cost.

To address a series of issues such as failure in full utilization of the energy density of silicon-based systems and poor cycling performance caused by the thickness rebound of silicon materials during processing, this application provides a negative electrode plate and an electrochemical apparatus including such negative electrode plate. The electrochemical apparatus can address the thickness rebound issue of silicon-based electrode plates during processing.

### Electrochemical Apparatus

The electrochemical apparatus includes a negative electrode plate, a positive electrode plate, a separator, and an electrolyte.

The negative electrode plate includes a negative electrode current collector and a negative electrode active material layer disposed on at least one surface of the negative electrode current collector. The negative electrode active material layer includes a negative electrode active material, and the negative electrode active material includes a silicon-based material. The silicon-based material is obtained by providing a surface coating layer on a surface of a silicon particle. The surface coating layer includes a soluble polymer, and the soluble polymer is soluble in the electrolyte. After the electrolyte is injected into the electrochemical apparatus, a mass concentration of the soluble polymer in the electrolyte is within a range of 0.2 wt % to 6 wt %.

Illustratively, after the electrolyte is injected into the electrochemical apparatus, the mass concentration of the soluble polymer in the electrolyte may be 0.2 wt %, 0.5 wt %, 0.8 wt %, 1 wt %, 1.3 wt %, 1.5 wt %, 1.8 wt %, 2 wt %, 2.5 wt %, 3 wt %, 3.5 wt %, 4 wt %, 4.5 wt %, 5 wt %, 6 wt %, or a range defined by any two of these values.

In some embodiments, the soluble polymer includes an alcohol-soluble resin, and the alcohol-soluble resin is selected from at least one of alcohol-soluble polyamide resin, alcohol-soluble acrylic resin, or alcohol-soluble polyurethane resin.

Specifically, in some examples, the alcohol-soluble resin includes any one of alcohol-soluble polyamide resin, alcohol-soluble acrylic resin, or alcohol-soluble polyurethane resin. In some other examples, the alcohol-soluble resin is selected from at least two of alcohol-soluble polyamide resin, alcohol-soluble acrylic resin, or alcohol-soluble polyurethane resin. In other examples, the alcohol-soluble resin includes alcohol-soluble polyamide resin, alcohol-soluble acrylic resin, and alcohol-soluble polyurethane resin.

In some embodiments, a molecular weight of the alcohol-soluble resin is within a range of 8×10³ to 1.5×10⁵. Illustratively, the molecular weight of the alcohol-soluble resin may be 8×10³, 9×10³, 1×10⁴, 3×10⁴, 5×10⁴, 8×10⁴, 1×10⁵, 1.5×10⁵, or a range defined by any two of these values.

In some embodiments, a mass ratio of the soluble polymer to the silicon particle is within a range of (0.05-1.2):1. Illustratively, the mass ratio of the soluble polymer to the silicon particle may be 0.05:1, 0.08:1, 0.1:1, 0.3:1, 0.35:1, 0.4:1, 0.5:1, 0.8:1, 1:1, 1.2:1, or a range defined by any two of these values.

In some embodiments, a mass ratio of the carbon nanotube to the silicon particle is within a range of (0.005-0.1):1. Illustratively, the mass ratio of the carbon nanotubes to the silicon particle may be 0.005:1, 0.008:1, 0.01:1, 0.02:1, 0.03:1, 0.05:1, 0.08:1, 0.1:1, or a range defined by any two of these values.

In some embodiments, the carbon nanotubes include single-walled carbon nanotubes, and an aspect ratio of the single-walled carbon nanotubes is within a range of 1×10⁴ to 4×10⁴. Illustratively, the aspect ratio of the single-walled carbon nanotubes may be 1×10⁴, 1.5×10⁴, 2×10⁴, 2.5×10⁴, 3×10⁴, 3.5×10⁴, 4×10⁴, or a range defined by any two of these values.

In some embodiments, a porosity of the negative electrode plate is within a range of 25% to 48%. Illustratively, the porosity of the negative electrode plate may be 25%, 28%, 30%, 33%, 35%, 38%, 40%, 45%, 48%, or a range defined by any two of these values.

In some embodiments, a thickness of the surface coating layer is within a range of 0.5 μm to 10 μm. Illustratively, the thickness of the surface coating layer may be 0.5 μm, 0.8 μm, 1 μm, 2μ, 3 μm, 4 μm, 5 μm, 6 μm, 8 μm, 9 μm, 10 μm, or a range defined by any two of these values.

In some embodiments, the negative electrode active material layer further includes a binder. Illustratively, the binder includes one or more of styrene-butadiene rubber (SBR), polyvinylidene fluoride (PVDF), polytetrafluoroethylene (PTFE), polyvinyl butyral (PVB), water-based acrylic resin (water-based acrylic resin), or carboxymethyl cellulose (CMC).

The negative electrode current collector may use materials such as metal foil or porous metal plate, for example, foil or porous plate made of metals such as copper, nickel, titanium, iron, or alloys thereof, such as copper foil.

The negative electrode plate can be prepared according to conventional methods in the art. Illustratively, a negative electrode active material and optional conductive agent and binder are dispersed in a solvent, to form a uniform negative electrode slurry, where the solvent may be at least one of water, ethanol, acetone, methyl ethyl ketone, dimethylformamide, N-methylpyrrolidone, diethylformamide, dimethyl sulfoxide, or tetrahydrofuran. The negative electrode slurry is applied on a negative electrode current collector, followed by processes such as drying and cold pressing to obtain a negative electrode plate. Illustratively, an oven temperature is set to 60° C. to 110° C., and the current collector coated with the slurry is dried in the oven to obtain an electrode material coating with excellent adhesion force and smooth surface. Another surface of the current collector is coated in the same manner.

### Preparation Method of Silicon-Based Material

Illustratively: carbon nanotubes and silicon particles are mixed at a mass ratio of (0.005-0.1):1 and dispersed using a disperser at 300 rpm/min to 500 rpm/min for 10 min to 20 min, and then a soluble polymer is added, where a mass ratio of the soluble polymer to the silicon particle is (0.05-1.2):1. Water is added for mixing. After mixing, a solid content of the resulting mixture solution is 50% to 60%. The mixture solution is then dispersed using the disperser at 800 rpm/min to 100 rpm/min for 2 h to 3 h. Water is added again for dilution to reduce the solid content of the mixture solution to 10% to 20%, and the mixture solution is then dispersed using the disperser at 800 rpm/min to 100 rpm/min for another 2 h to 3 h. The mixture solution is added to a cyclone separation tower with a temperature set to 115° C. to 125° C. Solid powder is collected.

The electrolyte includes an organic solvent, an electrolytic lithium salt, and an additive. The organic solvent includes at least two of ethylene carbonate (EC), propylene carbonate (PC), ethyl methyl carbonate (EMC), diethyl carbonate (DEC), dimethyl carbonate (DMC), dipropyl carbonate (DPC), methyl propyl carbonate (MPC), ethyl propyl carbonate (EPC), butylene carbonate (BC), fluoroethylene carbonate (FEC), methyl formate (MF), methyl acetate (MA), ethyl acetate (EA), propyl acetate (PA), methyl propionate (MP), ethyl propionate (EP), propyl propionate (PP), methyl butyrate (MB), ethyl butyrate (EB), 1,4-butyrolactone (GBL), sulfolane (SF), dimethyl sulfone (MSM), ethyl methyl sulfone (EMS), or ethyl sulfonyl ethane (ESE).

In some embodiments, in the organic solvent, a mass ratio of linear ester to cyclic ester is within a range of (1-4):(4-1).

The electrolytic lithium salt includes one or more of LiPF₆ (lithium hexafluorophosphate), LiBF₄ (lithium tetrafluoroborate), LiClO₄ (lithium perchlorate), LiAsF₆ (lithium hexafluoroarsenate), LiFSI (lithium bis(fluorosulfonyl)imide), LiTFSI (lithium bis(trifluoromethanesulfonyl)imide), LiTFS (lithium trifluoromethanesulfonate), LiDFOB (lithium difluoro(oxalato)borate), LiBOB (lithium bis(oxalato)borate), LiPO₂F₂ (lithium difluorophosphate), LiDFOP (lithium difluoro(oxalato)phosphate), or LiTFOP (lithium tetrafluoro(oxalato)phosphate).

The additive includes one or more of vinylene carbonate (VC), vinyl ethylene carbonate (VEC), succinonitrile (SN), adiponitrile (AND), 1,3-propane sultone (PST), tris(trimethylsilyl) phosphate (TMSP), or tris(trimethylsilyl)borate (TMSB).

### Others

The positive electrode plate includes a positive electrode current collector and a positive electrode active material layer disposed on at least one surface of the positive electrode current collector. The positive electrode active material in the positive electrode active material layer may be selected from one or more of lithium cobalt oxide, lithium nickel oxide, lithium manganese oxide, lithium nickel manganese oxide, lithium nickel cobalt manganese oxide, lithium nickel cobalt aluminum oxide, lithium iron phosphate, and compounds obtained by adding other transition metals or non-transition metals to the above compounds.

Illustratively, the positive electrode current collector may use materials such as metal foil or porous metal plate, for example, foil or porous plate made of metals such as aluminum, copper, nickel, titanium, iron, or alloys therefore, such as aluminum (Al) foil.

The positive electrode plate can be prepared according to conventional methods in the art.

There are no particular restrictions on the separator, and any well-known porous structure separator with electrochemical stability and chemical stability can be used, such as single-layer or multilayer films made of one or more of glass fiber, non-woven fabric, polyethylene (PE), polypropylene (PP), and polyvinylidene fluoride (PVDF).

The electrochemical apparatus can be prepared according to conventional methods in the art. Illustratively, the above positive electrode plate, separator, and negative electrode plate are stacked in sequence, with the separator positioned between the positive electrode plate and the negative electrode plate to provide isolation, to obtain an electrode assembly. Alternatively, the electrode assembly can be obtained by winding. The electrode assembly is placed in a packaging housing, an electrolyte is injected into the housing, and the housing is sealed to obtain an electrochemical apparatus.

The electrochemical apparatus of this application may be any apparatus in which an electrochemical reaction takes place, and specific examples thereof include all types of primary batteries or secondary batteries. In particular, the electrochemical apparatus is a lithium secondary battery, including a lithium metal secondary battery, a lithium-ion secondary battery, a lithium polymer secondary battery, or a lithium-ion polymer secondary battery.

### Electronic Device

An electronic device of this application includes any of the foregoing electrochemical apparatuses of this application. The electronic device of this application can be used for but not limited to laptops, pen-input type computers, mobile computers, e-book readers, portable phones, portable fax machines, portable copiers, portable printers, head-mounted stereo headphones, video recorders, liquid crystal display televisions, handheld cleaners, portable CD players, mini discs, transceivers, electronic notebooks, calculators, memory cards, portable recorders, radios, backup power supplies, motors, automobiles, motorcycles, electric bicycles, bicycles, lighting fixtures, toys, game consoles, clocks, power tools, flashlights, cameras, large household storage batteries, and lithium-ion capacitors.

The following provides examples and comparative examples to describe some embodiments of this application in more details. Unless otherwise stated, the parts, percentages, and ratios listed below are based on weight, and the raw materials used are all commercially available or synthesized by conventional methods.

### Example 1-1

### Preparation of Silicon-Based Material

Carbon nanotubes and silicon particles were mixed at a mass ratio of 0.01:1 and dispersed using a disperser at 300 rpm/min for 10 min, and then polyamide resin (with a molecular weight of 8×10³ to 1.5×10⁵) was added, where a mass ratio of the polyamide resin to the silicon particle was 0.35:1. Water was added for mixing. After mixing, a solid content of the mixture solution was 50%. The mixture solution was then dispersed using a disperser at 800 rpm/min for 2 h. Water was added again for dilution to reduce the solid content of the mixture solution to 10%, and the mixture solution was dispersed using a disperser at 800 rpm/min for another 2 h. Afterward, the mixture solution was added to a cyclone separation tower through a peristaltic pump, with a temperature of the cyclone separation tower set to 120° C.; and solid powder was collected to obtain a silicon-based material.

### Examples 1-2 to 1-17

These examples were the same as Example 1-1 except that during the preparation of the silicon-based material, some parameters and their values were adjusted, as detailed in Table 1.

### Comparative Example 1

This comparative example was the same as Example 1-1 except that the silicon-based material, that was silicon particles with a silicon content of 10%, was not coated with a coating layer on the surface.

### Comparative Examples 2 to 5

These comparative examples were the same as Example 1-1 except that during the preparation of the silicon-based material, some parameters and their values were adjusted, as detailed in Table 1.

### Preparation of Negative Electrode Plate

The prepared silicon-based material, a conductive agent acetylene black, a binder styrene-butadiene rubber (SBR), and a thickener sodium methyl cellulose (CMC) were mixed to uniformity at a mass ratio of 95:2:2:1 in a deionized water solvent, and the resulting mixture was applied on one side of a 9 μm Cu foil, and dried. The above steps were repeated on another side of the Cu foil to obtain a negative electrode plate having double sides coated with a negative electrode active layer. After coating, the negative electrode plate was dried, cold-pressed, and then cut into sheets with specifications of 74 mm×800 mm for later use.

### Preparation of Positive Electrode Plate

A positive electrode active material lithium cobalt oxide LiCoO₂, conductive carbon black Super-P, and a binder PVDF were mixed at a weight ratio of 97.6:1.3:1.1 in an N-methylpyrrolidone NMP solvent system, and the resulting mixture was thoroughly stirred using a vacuum mixer to obtain a positive electrode slurry. The positive electrode slurry was applied on two surfaces of a 9 μm Al foil substrate with a coating weight of 280 mg. After coating, the positive electrode plate was dried, cold-pressed, and then cut into sheets with specifications of 74 mm×800 mm for later use.

### Preparation of Electrolyte

In a glove box filled with a dry argon atmosphere, organic solvents ethylene carbonate (EC), diethyl carbonate (DEC), propyl propionate (PP), and adiponitrile (ADN) were mixed at a mass ratio of 1:2:1:0.15. Lithium hexafluorophosphate (LiPF₆) was then added to the above organic solvents, dissolved, and thoroughly mixed to obtain an electrolyte with a LiPF₆ concentration of 1.15 mol/L.

### Preparation of Separator

A porous polyethylene film with a thickness of 16 μm was used as the separator.

### Preparation of Lithium-Ion Battery

The prepared positive electrode plate, separator, and negative electrode plate were stacked in sequence and then wound to obtain an electrode assembly. After tab welding, the electrode assembly was placed in an aluminum-plastic film, dried in a vacuum oven at 80° C. for 12 h to remove moisture, and then the prepared electrolyte was injected, followed by processes such as vacuum sealing, standing, formation (the battery was charged at a constant current of 0.02 C to 3.5 V and then charged at a constant current of 0.1 C to 3.9 V), capacity testing, and shaping, to obtain a lithium-ion battery. In this application, unless otherwise specified, preparation can be carried out according to conventional technical means in the art.

### Testing Methods:

### (1) Testing Method for Mass Concentration

A lithium salt concentration C1 in the electrolyte was calculated through inductively coupled plasma (ICP) testing. A part of the electrolyte was taken and weighed as m1, and dried in an oven at 120° C. for 8 h, and a mass of the remaining solid residue was weighed as m2, where mass concentration of soluble polymer in electrolyte m wt %=(m2−C1*m1)/m1.

### (2) Testing Method for Thickness Expansion Rate

An expansion rate of the negative electrode plate was obtained by disassembling a cell to test an anode electrode plate. A fresh cell after formation was charged to 3.91 V, the corresponding cell was disassembled to obtain a negative electrode plate, and an average thickness of the negative electrode plate was measured using a micrometer to obtain a thickness T1. After cycling, the cell was charged at 1 C to a full charge voltage and then charged at the constant full charge voltage until the current reached 0.05 C, the corresponding cell was disassembled, and an average thickness of the negative electrode plate was measured using a micrometer to obtain a thickness T2, where expansion rate of negative electrode plate THK=(T2−T1)/T1.

### (3) Testing Method for High-Temperature Cycling Performance

At 45° C., a lithium-ion battery was charged at a constant current of 1 C to a full charge voltage of 4.5 V, then charged at the constant full charge voltage until the current reached 0.05 C, and discharged at a constant current of 1 C to 3.0 V. This constituted one charge-discharge cycle, and a discharge capacity of the first cycle of the lithium-ion battery was recorded. The lithium-ion battery was cycled 400 times according to the above method, and a capacity retention rate at the 400th cycle was calculated, where capacity retention rate %=discharge capacity of current cycle/discharge capacity of first cycle.

### (4) Testing Method for Rate Performance

At 25° C., the lithium-ion battery was charged at a constant current of 0.2 C to a full charge voltage, then charged at the constant full charge voltage until the current reached 0.02 C, and discharged at a constant current of 0.2 C to 3.0 V. A discharge capacity at the rate of 0.2 C was recorded.

At 25° C., the lithium-ion battery was charged at a constant current of 0.5 C to a full charge voltage, then charged at the constant full voltage until the current reached 0.02 C, and discharged at a constant current of 2 C to 3.0 V. A discharge capacity at 2 C rate was recorded.

$$Discharge capacity retention rate at 2 C ( \% ) = Discharge capacity at rate of 2 C / discharge capacity at rate of 0.2 C \times 100 \% .$$

TABLE 1

| | Silicon-based material | | | | | | | | | |
|---|---|---|---|---|---|---|---|---|---|---|
| | | | Coating layer | | | | | | | Discharge |
| | | | | | | Mass | | | | capacity |
| | | | | Mass | | ratio | | | Thickness | retention |
| | | | | ratio | | of | | Mass | expansion | rate |
| | | | | of | | carbon | | concentration | rate | at |
| | Silicon particles | | Polymer | polymer | | nanotube | | of | of | 2 C |
| | | Percentage | type/ | to | | to | | polymer | negative | after |
| | | of | molecular | silicon | Carbon | silicon | | in | electrode | 500 |
| | Type | silicon | weight | particle | nanotubes | particle | Thickness | electrolyte | plate | cycles |
| Comparative | Silicon- | 10% | / | / | / | / | / | 0% | 16.0% | 64.5% |
| Example 1 | carbon | | | | | | | | | |
| Comparative | Silicon- | 10% | Polyamide | 1:1 | Single- | 0.01:1 | 0.5 μm | 8% | 15.5% | 65.3% |
| Example 2 | oxygen | | resin/4 × 10³- | | walled/average | | | | | |
| | | | 6 × 10³ | | diameter 2 | | | | | |
| | | | | | nm/average | | | | | |
| | | | | | length 50 μm | | | | | |
| Comparative | Silicon- | 10% | Polyamide | 1.4:1 | Single- | 0.01:1 | 15 μm | 0.01% | 15.4% | 65.7% |
| Example 3 | carbon | | resin/3.5 × 10⁵- | | walled/average | | | | | |
| | | | 6 × 10⁵ | | diameter 2 | | | | | |
| | | | | | nm/average | | | | | |
| | | | | | length 50 μm | | | | | |
| Comparative | Silicon- | 10% | Polyamide | 0.04:1 | Single- | 0.01:1 | 0.35 μm | 0.15% | 15.0% | 67.0% |
| Example 4 | carbon | | resin/8 × 10³- | | walled/average | | | | | |
| | | | 1.5 × 10⁵ | | diameter 2 | | | | | |
| | | | | | nm/average | | | | | |
| | | | | | length 50 μm | | | | | |
| Comparative | Silicon- | 10% | Polyamide | 1:1 | Single- | 0.01:1 | 0.45 μm | 7% | 16.5% | 66.3% |
| Example 5 | carbon | | resin/4 × 10³- | | walled/average | | | | | |
| | | | 6 × 10³ | | diameter 2 | | | | | |
| | | | | | nm/average | | | | | |
| | | | | | length 50 μm | | | | | |
| Example 1-1 | Silicon- | 10% | Polyamide | 0.35:1 | Single- | 0.01:1 | 2.5 μm | 1.50% | 9.1% | 79.3% |
| | carbon | | resin/8 × 10³- | | walled/average | | | | | |
| | | | 1.5 × 10⁵ | | diameter 2 | | | | | |
| | | | | | nm/average | | | | | |
| | | | | | length 50 μm | | | | | |
| Example 1-2 | Silicon- | 10% | Acrylic | 0.35:1 | Single- | 0.01:1 | 2.5 μm | 1.44% | 9.0% | 81.6% |
| | carbon | | resin/8 × 10³- | | walled/average | | | | | |
| | | | 1.5 × 10⁵ | | diameter 2 | | | | | |
| | | | | | nm/average | | | | | |
| | | | | | length 50 μm | | | | | |
| Example 1-3 | Silicon- | 10% | Polyurethane | 0.35:1 | Single- | 0.01:1 | 2.5 μm | 1.38% | 8.2% | 82.0% |
| | carbon | | resin/8 × 10³- | | walled/average | | | | | |
| | | | 1.5 × 10⁵ | | diameter 2 | | | | | |
| | | | | | nm/average | | | | | |
| | | | | | length 50 μm | | | | | |
| Example 1-4 | Silicon- | 10% | Polyurethane | 0.3:1 | Single- | 0.01:1 | 2.3 μm | 1.38% | 8.5% | 79.5% |
| | carbon | | resin/8 × 10³- | | walled/average | | | | | |
| | | | 1.5 × 10⁵ | | diameter 2 | | | | | |
| | | | | | nm/average | | | | | |
| | | | | | length 50 μm | | | | | |
| Example 1-5 | Silicon- | 10% | Polyurethane | 0.5:1 | Single- | 0.01:1 | 4 μm | 1.45% | 9.3% | 77.4% |
| | carbon | | resin/8 × 10³- | | walled/average | | | | | |
| | | | 1.5 × 10⁵ | | diameter 2 | | | | | |
| | | | | | nm/average | | | | | |
| | | | | | length 50 μm | | | | | |
| Example 1-6 | Silicon- | 10% | Polyurethane | 0.2:1 | Single- | 0.01:1 | 2 μm | 1.19% | 11.5% | 73.9% |
| | carbon | | resin/8 × 10³- | | walled/average | | | | | |
| | | | 1.5 × 10⁵ | | diameter 2 | | | | | |
| | | | | | nm/average | | | | | |
| | | | | | length 50 μm | | | | | |
| Example 1-7 | Silicon- | 10% | Polyurethane | 0.35:1 | Single- | 0.01:1 | 2.5 μm | 1.39% | 12.0% | 74.7% |
| | carbon | | resin/8 × 10³- | | walled/average | | | | | |
| | | | 1.5 × 10⁵ | | diameter 2 | | | | | |
| | | | | | nm/average | | | | | |
| | | | | | length 80 μm | | | | | |
| Example 1-8 | Silicon- | 10% | Polyurethane | 0.35:1 | Single- | 0.01:1 | 2.5 μm | 1.27% | 13.1% | 71.5% |
| | carbon | | resin/8 × 10³- | | walled/average | | | | | |
| | | | 1.5 × 10⁵ | | diameter 2 | | | | | |
| | | | | | nm/average | | | | | |
| | | | | | length 20 μm | | | | | |
| Example 1-9 | Silicon- | 10% | Polyurethane | 1.2:1 | Single- | 0.01:1 | 10 μm | 5.93% | 13.7% | 70.3% |
| | carbon | | resin/8×10³- | | walled/average | | | | | |
| | | | 1.5×10⁵ | | diameter 2 | | | | | |
| | | | | | nm/average | | | | | |
| | | | | | length 50 μm | | | | | |
| Example 1-10 | Silicon- | 10% | Polyurethane | 0.05:1 | Single- | 0.01:1 | 0.5 μm | 0.20% | 12.7% | 72.9% |
| | carbon | | resin/8 × 10³- | | walled/average | | | | | |
| | | | 1.5 × 10⁵ | | diameter 2 | | | | | |
| | | | | | nm/average | | | | | |
| | | | | | length 50 μm | | | | | |
| Example 1-11 | Silicon- | 10% | Polyurethane | 0.35:1 | Single- | 0.003:1 | 2.2 μm | 1.29% | 13.5% | 70.60% |
| | carbon | | resin/8 × 10³- | | walled/average | | | | | |
| | | | 1.5 × 10⁵ | | diameter 2 | | | | | |
| | | | | | nm/average | | | | | |
| | | | | | length 50 μm | | | | | |
| Example 1-12 | Silicon- | 10% | Polyurethane | 0.35:1 | Single- | 0.005:1 | 2.3 μm | 1.36% | 12.50% | 72.70% |
| | carbon | | resin/8 × 10³- | | walled/average | | | | | |
| | | | 1.5 × 10⁵ | | diameter 2 | | | | | |
| | | | | | nm/average | | | | | |
| | | | | | length 50 μm | | | | | |
| Example 1-13 | Silicon- | 10% | Polyurethane | 0.35:1 | Single- | 0.05:1 | 2.8 μm | 1.36% | 12.80% | 73.10% |
| | carbon | | resin/8 × 10³- | | walled/average | | | | | |
| | | | 1.5 × 10⁵ | | diameter 2 | | | | | |
| | | | | | nm/average | | | | | |
| | | | | | length 50 μm | | | | | |
| Example 1-14 | Silicon- | 10% | Polyurethane | 0.35:1 | Single- | 0.10:1 | 3.2 μm | 1.30% | 13.00% | 71.70% |
| | carbon | | resin/8 × 10³- | | walled/average | | | | | |
| | | | 1.5 × 10⁵ | | diameter 2 | | | | | |
| | | | | | nm/average | | | | | |
| | | | | | length 50 μm | | | | | |
| Example 1-15 | Silicon- | 10% | Polyurethane | 0.35:1 | Single- | 0.01:1 | 2.5 μm | 1.38% | 13.30% | 71.40% |
| | carbon | | resin/8 × 10³- | | walled/average | | | | | |
| | | | 1.5 × 10⁵ | | diameter 2 | | | | | |
| | | | | | nm/average | | | | | |
| | | | | | length 60 μm | | | | | |
| Example 1-16 | Silicon- | 10% | Polyvinylidene | 0.35:1 | Single- | 0.01:1 | 2.5 μm | 1.22% | 13.7% | 70.5% |
| | carbon | | fluoride/8 × 10³- | | walled/average | | | | | |
| | | | 1.5 × 10⁵ | | diameter 2 | | | | | |
| | | | | | nm/average | | | | | |
| | | | | | length 90 μm | | | | | |
| Example 1-17 | Silicon- | 10% | Polyurethane | 0.35:1 | Single- | 0.01:1 | 2.5 μm | 1.38% | 13.10% | 72% |
| | oxygen | | resin/8 × 10³- | | walled/average | | | | | |
| | | | 1.5 × 10⁵ | | diameter 2 | | | | | |
| | | | | | nm/average | | | | | |
| | | | | | length 50 μm | | | | | |

Referring to Table 1, by comparing Comparative Example 1 with Example 1-1, it can be seen that the silicon particles in Comparative Example 1 are not coated. The thickness expansion rate of the negative electrode plate using silicon particles without a surface coating layer is as high as 16.0%, and the discharge capacity retention rate at 2 C is only 64.5%. In contrast, the silicon particles in Example 1-1 are coated with the surface coating layer. When the silicon-based material of Example 1-1 is used as the negative electrode active material to prepare a lithium-ion battery, the thickness expansion rate of the negative electrode plate is as low as 9.1%, showing a significant reduction of about 7% compared to Comparative Example 1. Moreover, the discharge capacity retention rate of the negative electrode plate at 2 C is as high as 79.3%, showing a significant increase of about 15% compared to Comparative Example 1.

From the comparison between the comparison Examples 1-2 and 1-3 and Example 1-1, in Examples 1-2 and 1-3, other suitable alcohol-soluble resins are used as the soluble polymer to prepare the surface coating layer for coating the silicon particles. The lithium-ion batteries prepared exhibit similar or better technical effects compared to Example 1-1. In particular, in Example 1-3, the alcohol-soluble resin used is polyurethane resin, the thickness expansion rate of the negative electrode plate in the lithium-ion battery prepared in Example 1-3 is only 8.2%, and the discharge capacity retention rate at 2 C thereof is increased to 82%.

From the comparison between Examples 1-4, 1-5, and 1-6 and Example 1-3, in Examples 1-4, 1-5, and 1-6, the mass ratio of the alcohol-soluble polymer to the silicon particle is further adjusted. It can be seen that when the mass ratio is reduced (the fraction of the alcohol-soluble polymer is reduced), the thickness of the surface coating layer is reduced accordingly, so that the mass concentration of the alcohol-soluble polymer in the electrolyte is outside an appropriate range. The thickness expansion rate of the negative electrode plate in the prepared lithium-ion battery significantly increased to 8.5%, and the discharge capacity retention rate at 2 C thereof is decreased to 79.5%. Example 1-9 shows similar results. Moreover, when the mass ratio is increased (the fraction of the alcohol-soluble polymer is increased), the thickness of the surface coating layer is increased accordingly, so that the mass concentration of the alcohol-soluble polymer in the electrolyte is also outside an appropriate range. Example 1-9 also exhibits similar results.

From the comparison between Examples 1-11 to 1-14 and Example 1-3, it can be seen that the presence of an appropriate amount of single-walled carbon nanotubes in the surface coating layer can further reduce the thickness expansion rate of the negative electrode plate. From the comparison between Examples 1-7, 1-8, 1-15, and 1-16 and Example 1-3, it can be seen that adjusting the aspect ratio of single-walled carbon nanotubes to an appropriate range is more conducive to reducing the thickness expansion rate of the negative electrode plate and improving the rate performance of the lithium-ion battery.

Examples 2-1 to 2-11 in Table 2 were all adjusted based on Example 1-11, with details shown in Table 2.

TABLE 2

| | | | | Mass | | Thickness | Capacity |
|---|---|---|---|---|---|---|---|
| | Negative electrode | | | ratio | Porosity | expansion | retention |
| | active material | | | of linear | of | rate of | rate at |
| | Proportion of | Proportion | | ester to | negative | negative | 45° C. |
| | silicon | of | Components of | cyclic | electrode | electrode | after |
| | particles | graphite | electrolyte | ester | plate | plate | 400 cycles |
| Example 2-1 | 10% | 80% | EC:DEC:ADN = | 1:2 | 32% | 10.10% | 75.0% |
| | | | 2:1:0.15 | | | | |
| Example 2-2 | 10% | 80% | EC:DEC:PP:ADN = | 1:1 | 33% | 11.71% | 73.5% |
| | | | 3:2:1:0.15 | | | | |
| Example 2-3 | 10% | 80% | EC:DEC:PP:ADN = | 2:1 | 33% | 10.99% | 73.7% |
| | | | 1:1:1:0.15 | | | | |
| Example 2-4 | 10% | 80% | EC:DEC:PP:ADN = | 3:1 | 34% | 10.20% | 74.5% |
| | | | 1:2:1:0.15 | | | | |
| Example 2-5 | 10% | 80% | EC:DEC:PP:ADN = | 4:1 | 32% | 12.78% | 73.2% |
| | | | 1:3:1:0.15 | | | | |
| Example 2-6 | 10% | 80% | EC:DEC:PP:ADN = | 1:4 | 31% | 13.00% | 73.1% |
| | | | 8:1:1:0.15 | | | | |
| Example 2-7 | 2% | 92% | EC:DEC:PP: ADN = | 3:1 | 25% | 13.20% | 75.0% |
| | | | 1:2:1:0.15 | | | | |
| Example 2-8 | 4% | 92% | EC:DEC:PP:ADN = | 3:1 | 30% | 12.50% | 73.80% |
| | | | 1:2:1:0.15 | | | | |
| Example 2-9 | 75% | 3% | EC:DEC:PP:ADN = | 3:1 | 40% | 12.20% | 72.80% |
| | | | 1:2:1:0.15 | | | | |
| Example 2-10 | 87% | 3% | EC:DEC:PP: ADN = | 3:1 | 45% | 12.50% | 72.00% |
| | | | 1:2:1:0.15 | | | | |
| Example 2-11 | 90% | 3% | EC:DEC:PP:ADN = | 3:1 | 48% | 13.10% | 70.90% |
| | | | 1:2:1:0.15 | | | | |

Referring to Table 2, it can be seen that making the mass ratio of linear ester to cyclic ester in the electrolyte be within an appropriate range is conducive to reducing the thickness expansion rate of the negative electrode plate. Additionally, an appropriate porosity of the negative electrode plate can also better address the thickness rebound issue of silicon-based electrode plates during processing.

The above descriptions are only preferred embodiments of this application and are not intended to limit this application. Any modifications, equivalent substitutions, improvements, and the like made within the spirit and principles of this application should be included within the protection scope of this application.

What is claimed is:

1. A negative electrode plate, wherein the negative electrode plate comprises a negative electrode active material, the negative electrode active material comprises a silicon-based material, the silicon-based material includes a silicon particle and a surface coating layer provided on a surface of the silicon particle, the surface coating layer comprises a soluble polymer, and the soluble polymer is configured to be soluble in an electrolyte; and
a mass ratio of the soluble polymer to the silicon particle is (0.05-1.2):1;
wherein the electrolyte consists of solvents of ethylene carbonate (EC), diethyl carbonate (DEC), propyl propionate (PP), and adiponitrile (ADN) at a mass ratio of 1:2:1:0.15, and LiPF₆ at a concentration of 1.15 mol/L in the solvents.

2. The negative electrode plate according to claim 1, wherein the mass ratio of the soluble polymer to the silicon particle is (0.3-0.5):1.

3. The negative electrode plate according to claim 1, wherein the surface coating layer further comprises carbon nanotubes; and
a mass ratio of the carbon nanotube to the silicon particle is (0.005-0.1):1.

4. An electrochemical apparatus, wherein the electrochemical apparatus comprises a negative electrode plate;
the negative electrode plate comprises a negative electrode active material, the negative electrode active material comprises a silicon-based material, the silicon-based material includes a silicon particle and a surface coating layer provided on a surface of the silicon particle;
the surface coating layer comprises a soluble polymer, and the soluble polymer is soluble in an electrolyte; and
after the electrolyte is injected into the electrochemical apparatus, a mass concentration of the soluble polymer in the electrolyte is 0.2 wt % to 6 wt %;
wherein the electrolyte comprises solvents of ethylene carbonate (EC), diethyl carbonate (DEC), propyl propionate (PP), and adiponitrile (ADN) at a mass ratio of 1:2:1:0.15, and LiPF₆ at a concentration of 1.15 mol/L in the solvents.

5. The electrochemical apparatus according to claim 4, wherein after the electrolyte is injected into the electrochemical apparatus, the mass concentration of the soluble polymer in the electrolyte is 1.3 wt % to 1.5 wt %.

6. The electrochemical apparatus according to claim 4, wherein the surface coating layer further comprises carbon nanotubes; and
the electrochemical apparatus satisfies at least one of the following conditions:
(1) a mass ratio of the soluble polymer to the silicon particle is (0.05-1.2):1;
(2) a mass ratio of the carbon nanotube to the silicon particle is (0.005-0.1):1; or
(3) the carbon nanotubes comprise single-walled carbon nanotubes, wherein an aspect ratio of the single-walled carbon nanotube is 1×10⁴ to 4×10⁴.

7. The electrochemical apparatus according to claim 6, wherein
the electrochemical apparatus satisfies at least one of the following conditions:
(1) the mass ratio of the soluble polymer to the silicon particle is (0.3-0.5):1;
(2) the mass ratio of the carbon nanotube to the silicon particle is (0.01-0.05):1; or
(3) the carbon nanotubes comprise single-walled carbon nanotubes, wherein an aspect ratio of the single-walled carbon nanotube is 2.5×10⁴ to 3×10⁴.

8. The electrochemical apparatus according to claim 4, wherein the soluble polymer comprises an alcohol-soluble resin, and satisfies at least one of the following conditions:
(1) a molecular weight of the alcohol-soluble resin is 8×10³ to 1.5×10⁵; or
(2) the alcohol-soluble resin is at least one selected from alcohol-soluble polyamide resin, alcohol-soluble acrylic resin, or alcohol-soluble polyurethane resin.

9. The electrochemical apparatus according to claim 4, wherein a dissolution amount of the soluble polymer in a specific solution is greater than 80%; and
the specific solution comprises linear ester and cyclic ester, and a mass ratio of the linear ester to the cyclic ester is 3:1.

10. The electrochemical apparatus according to claim 4, satisfying:
a porosity of the negative electrode plate is 25% to 48%.

11. The electrochemical apparatus according to claim 4, satisfying at least one of the following conditions:
(1) a porosity of the negative electrode plate is 25% to 33%; or
(2) the electrolyte comprises linear ester and cyclic ester, and a mass ratio of the linear ester to the cyclic ester is (1-3):1.

12. The electrochemical apparatus according to claim 4, wherein a thickness of the surface coating layer is 0.5 μm to 10 μm.

13. The electrochemical apparatus according to claim 4, wherein the negative electrode active material further comprises graphite, and a mass ratio of the silicon particle to the graphite is 1:23 to 29:1.

14. An electronic device, wherein the electronic device comprises an electrochemical apparatus, wherein the electrochemical apparatus comprises a negative electrode plate;
the negative electrode plate comprises a negative electrode active material, the negative electrode active material comprises a silicon-based material, the silicon-based material includes a silicon particle and a surface coating layer provided on a surface of the silicon particle;
the surface coating layer comprises a soluble polymer, and the soluble polymer is configured to be soluble in an electrolyte; and
after the electrolyte is injected into the electrochemical apparatus, a mass concentration of the soluble polymer in the electrolyte is 0.2 wt % to 6 wt %;
wherein the electrolyte comprises solvents of ethylene carbonate (EC), diethyl carbonate (DEC), propyl propionate (PP), and adiponitrile (ADN) at a mass ratio of 1:2:1:0.15, and LiPF₆ at a concentration of 1.15 mol/L in the solvents.

15. The electronic device according to claim 14, wherein the mass ratio of the soluble polymer to the silicon particle is (0.3-0.5):1.

16. The electronic device according to claim 14, wherein the surface coating layer further comprises carbon nanotubes; and
a mass ratio of the carbon nanotube to the silicon particle is (0.005-0.1):1.

17. The electronic device according to claim 14, wherein after the electrolyte is injected into the electrochemical apparatus, the mass concentration of the soluble polymer in the electrolyte is 1.3 wt % to 1.5 wt %.

18. The electronic device according to claim 14, wherein the surface coating layer further comprises carbon nanotubes; and
the electrochemical apparatus satisfies at least one of the following conditions:
(1) a mass ratio of the soluble polymer to the silicon particle is (0.05-1.2):1;
(2) a mass ratio of the carbon nanotube to the silicon particle is (0.005-0.1):1; or
(3) the carbon nanotubes comprise single-walled carbon nanotubes, wherein an aspect ratio of the single-walled carbon nanotube is 1×10⁴ to 4×10⁴.

19. The electronic device according to claim 18, wherein the electrochemical apparatus satisfies at least one of the following conditions:
(1) the mass ratio of the soluble polymer to the silicon particle is (0.3-0.5):1;
(2) the mass ratio of the carbon nanotube to the silicon particle is (0.01-0.05):1; or
(3) the carbon nanotubes comprise single-walled carbon nanotubes, wherein an aspect ratio of the single-walled carbon nanotube is 2.5×10⁴ to 3×10⁴.

20. The electronic device according to claim 14, wherein the soluble polymer comprises an alcohol-soluble resin, and satisfies at least one of the following conditions:
(1) a molecular weight of the alcohol-soluble resin is 8×10³ to 1.5×10⁵; or
(2) the alcohol-soluble resin is at least one selected from alcohol-soluble polyamide resin, alcohol-soluble acrylic resin, or alcohol-soluble polyurethane resin.
